(19) United States
(12) Patent Application Publication
(10) Pub. No.: US 2026/0128406 A1
(43) Pub. Date: May 7, 2026

(54) BATTERY

(71) Applicants: Hyundai Motor Company, Seoul (KR); Kia Corporation, Seoul (KR)

(72) Inventors: Gun Goo Lee, Hwaseong-Si (KR); Jeong Won Cho, Hwaseong-Si (KR)

(73) Assignees: Hyundai Motor Company, Seoul (KR); Kia Corporation, Seoul (KR)

(21) Appl. No.: 19/219,086

(22) Filed: May 27, 2025

(30) Foreign Application Priority Data
Nov. 5, 2024 (KR) 10-2024-0155658

(51) Int. Cl. H01M 10/6556; H01M 10/613; H01M 10/647; H01M 10/6568; H01M 10/6569

(52) U.S. Cl. CPC H01M 10/6556; H01M 10/613; H01M 10/647; H01M 10/6568; H01M 10/6569

(57) ABSTRACT

A battery includes a battery accommodation portion accommodating an electrode stack including an electrode and a separator, and a cooling portion including recessed grooves formed in a plate surface of the cooling portion, the cooling portion being disposed to be tightly attached to an external surface of the battery accommodation portion and defining flow paths in a space between the recessed grooves and the external surface of the battery accommodation portion so that a refrigerant flows along the flow paths so that performance in dissipating heat from a battery cell may be improved, shortening a fast-charging time, ensuring a high output of the battery cell, and reducing costs and weight.

### CROSS-REFERENCE TO RELATED APPLICATION

The present application claims priority to Korean Patent Application No. 10-2024-0155658 filed on Nov. 5, 2024, the entire contents of which is incorporated herein for all purposes by this reference.

### BACKGROUND OF THE PRESENT DISCLOSURE

### Field of the Present Disclosure

The present disclosure relates to a battery, and more particularly, to a battery, in which heat dissipation performance of a battery cell may be improved, shortening a fast-charging time, ensuring a high output of the battery cell, and reducing costs and weight.

### Description of Related Art

With the increasing technological development and demands for mobile devices such as mobile phones, laptops, camcorders, and digital cameras, studies on technologies related to secondary batteries capable of being charged and discharged are being actively conducted.

Furthermore, as an alternative energy source to fossil fuel that causes air pollutants, the secondary battery is being applied to an electric vehicle (EV), a hybrid electric vehicle (HEV), a plug-in hybrid electric vehicle (P-HEV), or the like. Therefore, the need to develop secondary batteries is increasing.

As currently commercially available secondary batteries, there are a nickel cadmium battery, a nickel hydrogen battery, a nickel zinc battery, a lithium secondary battery, and the like. Among these batteries, in comparison with the nickel-based secondary battery, the lithium secondary battery has almost no memory effect and is in the spotlight for their free charging or discharging. Furthermore, the lithium secondary battery has a very low self-discharge rate and a high energy density, and thus the lithium secondary battery is in the limelight.

Meanwhile, when the above secondary battery is used for a device that requires a large capacity and a high voltage, such as an electric vehicle, the secondary battery is used in a form of a battery cell assembly or a battery pack with a structure in which a plurality of battery cells are disposed.

The battery cell assembly, the battery pack, or the like may be affected by various operation environments of the device, and for example, the charging amount and output of the battery pack or the like may significantly vary depending on temperature conditions. Therefore, a cooling means or a heating means is also provided together to maintain a temperature of the battery pack under a predetermined condition.

Because the battery cells are densely crammed in a small space, it is very important to easily dissipate heat generated from each of the battery cells.

A process of charging or discharging the battery cells is carried out by an electrochemical reaction. For the present reason, if heat, which is generated from the battery module during the charging or discharging process, is not effectively removed, the heat accumulates, and as a result, deterioration of the battery module may be accelerated and it may lead to ignition or explosion in some instances.

Examples of common cooling means may include water-cooled and air-cooled cooling means. The water-cooled cooling means is provided with a flow path provided outside or inside the battery pack so that a refrigerant may flow along the flow path, and the water-cooled cooling means includes a port protruding outward to circulate the refrigerant.

However, in case that the port is damaged by an external impact or the like applied thereto, there is a risk that the refrigerant may enter the inside of the battery pack, which leads a severe accident.

To prevent the risk, a coolant channel is mounted on the outside of a battery system to prevent a risk of a short circuit in the battery due to a leak of a coolant. However, in the instant case, in case that single-sided cooling is applied, there is a restriction in transferring the heat, which is generated from the battery cell, to the coolant channel because of low thermal conductivity of the battery cell. In case that double-sided cooling is applied, there is a problem in that a large amount of costs are incurred because of the addition of the coolant channel, and various constraints occur because a process of avoiding a venting hole is required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery, in which performance in dissipating heat from a battery cell may be improved, shortening a fast-charging time, ensuring a high output of the battery cell, and reducing costs and weight.

To achieve the above-mentioned object, the present disclosure provides a battery including: a battery accommodation portion accommodating an electrode stack including an electrode and a separator; and a cooling portion including recessed grooves formed in a plate surface of the cooling portion, the cooling portion being disposed to be tightly attached to an external surface of the battery accommodation portion and defining flow paths in a space between the recessed grooves and the external surface of the battery accommodation portion so that a refrigerant flows along the flow paths.

In the instant case, regions of the flow paths, which are disposed at end portions of the plate surface of the cooling portion, may be repeatedly bent so that the flow paths may be continuously formed in a direction of the plate surface of the cooling portion, and first and second opposite end portions of the flow path may fluidically communicate with each other to define a closed loop.

Furthermore, the cooling portion may include: a vaporization portion disposed to be tightly attached to at least one side surface of the battery accommodation portion so that the refrigerant vaporizes in the flow paths; and a condensation portion disposed to be tightly attached to a lower surface of the battery accommodation portion and configured to pass through an external coolant so that the refrigerant condenses in the flow paths.

Furthermore, the cooling portion may be configured by a single cooling plate including a plate shape, and the cooling plate may be bent so that one portion of the cooling plate defines the vaporization portion tightly attached to one side surface of the battery accommodation portion, and the other portion of the cooling plate defines the condensation portion so that a longitudinal section including a ‘L’ shape as a whole may be formed.

Furthermore, the cooling portion may be configured by a plurality of cooling plates each including a plate shape, and the cooling plates may be joined to one another by brazing so that some of the cooling plates define the vaporization portion tightly attached to one side surface of the battery accommodation portion, and some of the remaining cooling plates define the condensation portion so that a longitudinal section including a ‘L’ shape as a whole may be formed.

Furthermore, the cooling portion may be provided as two cooling portions disposed to be symmetric with respect to the battery accommodation portion so that the vaporization portions may be respectively tightly attached to two opposite surfaces of the battery accommodation portion, and the condensation portions may be tightly attached to the lower surface of the battery accommodation portion.

Furthermore, the cooling portion may be configured by a single cooling plate including a plate shape, and a plurality of portions of the cooling plate may be bent so that some of the plurality of portions define the vaporization portions tightly attached to two opposite surfaces of the battery accommodation portion, and some of the remaining plurality of portions define the condensation portion tightly attached to the lower surface of the battery accommodation portion.

Furthermore, the vaporization portions may be formed at two opposite sides based on a bent region of the cooling plate, and the condensation portion, which is in thermal contact with the coolant, may be formed between the vaporization portions.

Furthermore, the vaporization portion may be disposed on a side surface of the battery accommodation portion including a relatively larger area than an area of the condensation portion.

Furthermore, the cooling portion may be joined to the battery accommodation portion by brazing.

Furthermore, the cooling portion may be formed integrally with the battery accommodation portion.

Furthermore, the battery accommodation portion may be configured as an angular cell.

According to the battery according to an exemplary embodiment of the present disclosure described above, the performance in dissipating heat from the battery cell may be improved, shortening the fast-charging time, ensuring the high output of the battery cell, and reducing the costs and weight.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view exemplarily illustrating a structure in which a front stack of a battery according to an exemplary embodiment of the present disclosure is separated.

FIG. 2 is an exploded perspective view exemplarily illustrating that a battery according to various exemplary embodiments of the present disclosure is disassembled.

FIG. 3 is a perspective view exemplarily illustrating a structure in which the battery according to the various exemplary embodiments of the present disclosure is assembled.

FIG. 4 is a perspective view exemplarily illustrating a structure of a flow path formed in the battery according to the various exemplary embodiments of the present disclosure.

FIG. 5 is an exploded perspective view exemplarily illustrating that a battery according to various exemplary embodiments of the present disclosure is disassembled.

FIG. 6 is a perspective view exemplarily illustrating a structure in which the battery according to the various exemplary embodiments of the present disclosure is assembled.

FIG. 7 is a perspective view exemplarily illustrating a structure of a flow path formed in the battery according to the various exemplary embodiments of the present disclosure.

FIG. 8 is an exploded perspective view exemplarily illustrating that a battery according to various exemplary embodiments of the present disclosure is disassembled.

FIG. 9 is a perspective view exemplarily illustrating a structure in which the battery according to the various exemplary embodiments of the present disclosure is assembled.

FIG. 10 is a perspective view exemplarily illustrating a structure of a flow path formed in the battery according to the various exemplary embodiments of the present disclosure.

FIG. 11 is a top plan view exemplarily illustrating a structure of a flow path formed in a refrigerant portion of the battery according to an exemplary embodiment of the present disclosure.

FIG. 12 is a top plan view exemplarily illustrating a structure in which the battery according to an exemplary embodiment of the present disclosure is provided at one side of a coolant channel.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a battery according to an exemplary embodiment of the present disclosure will be described in more detail with reference to the accompanying drawings.

However, the technical spirit of the present disclosure is not limited to exemplary embodiments described herein but may be implemented in various different forms. At least one of the constituent elements in the exemplary embodiments of the present disclosure may be selectively combined and substituted for use within the scope of the technical spirit of the present disclosure.

Furthermore, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

Furthermore, the terms used in the exemplary embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

Furthermore, the terms such as first, second, A, B, (a), and (b) may be used to describe constituent elements of the exemplary embodiments of the present disclosure.

These terms are used only for discriminating one constituent element from another constituent element, and the nature, the sequences, or the orders of the constituent elements are not limited by the terms.

Furthermore, when one constituent element is referred to as being ‘connected,’ ‘coupled,’ or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

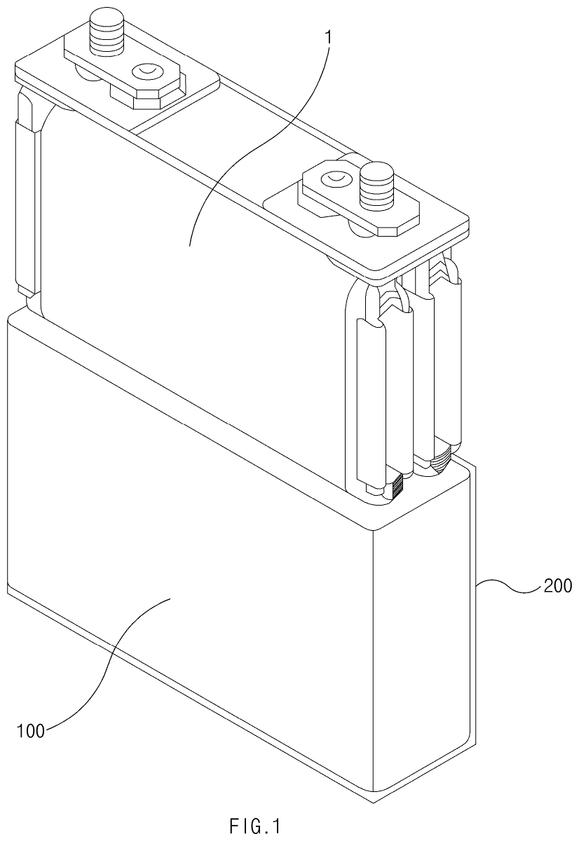

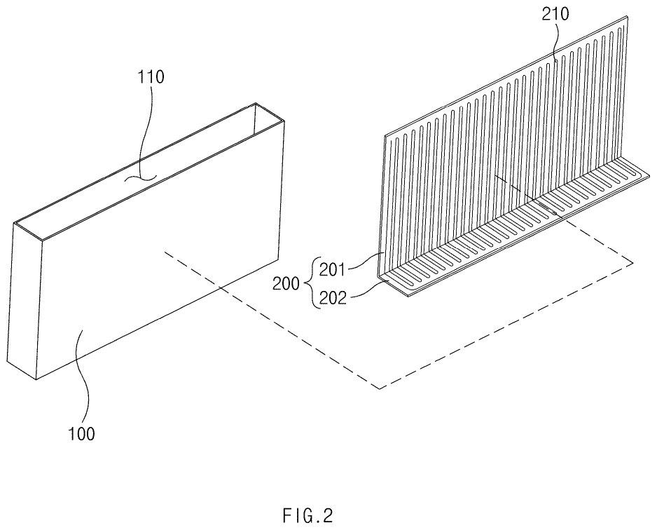

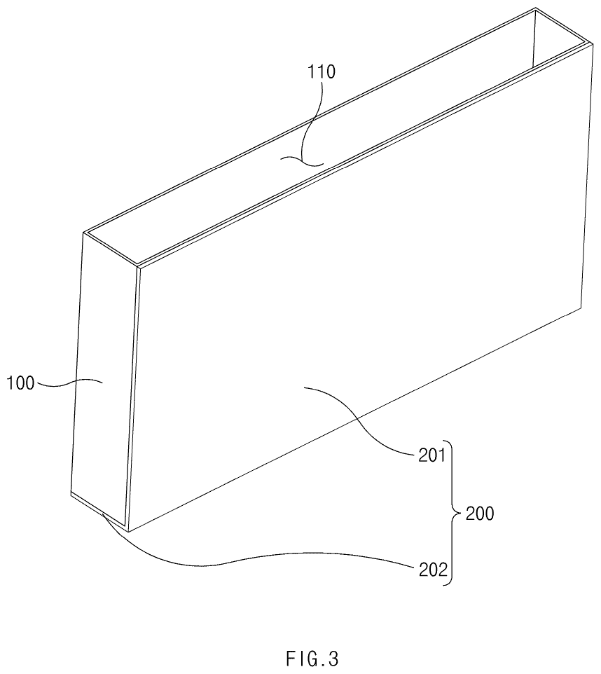

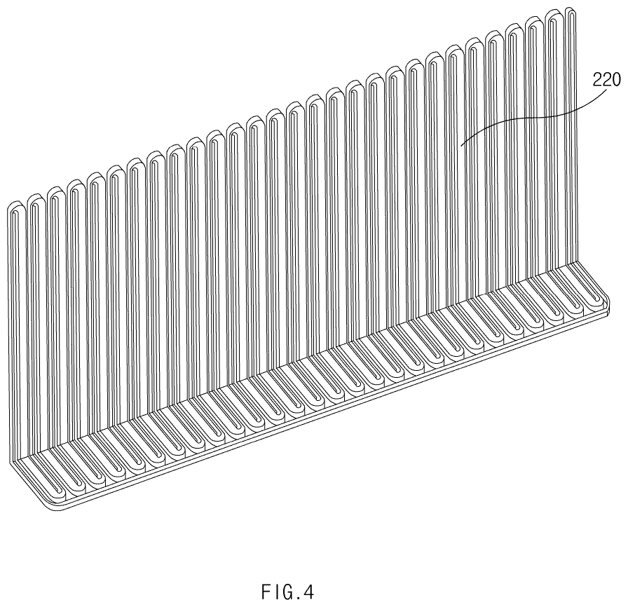

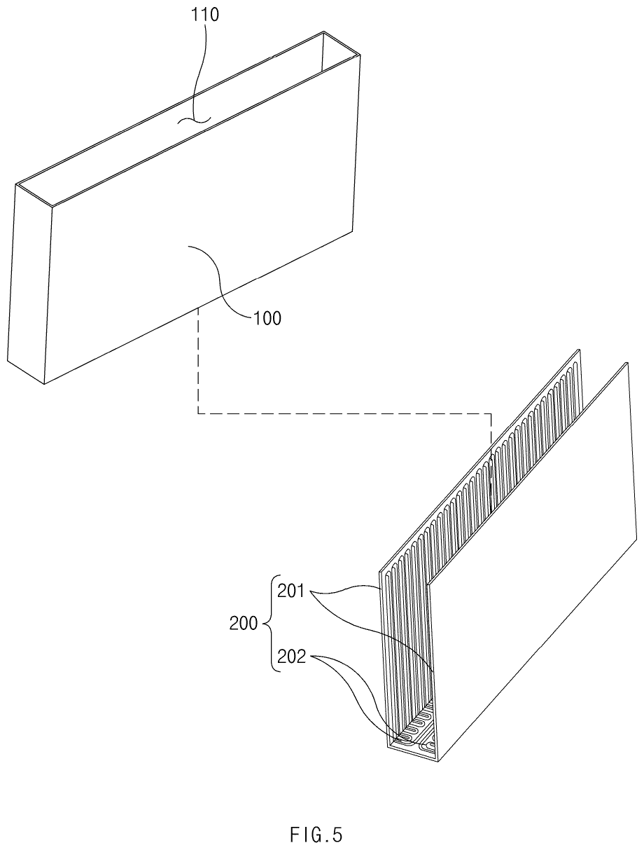

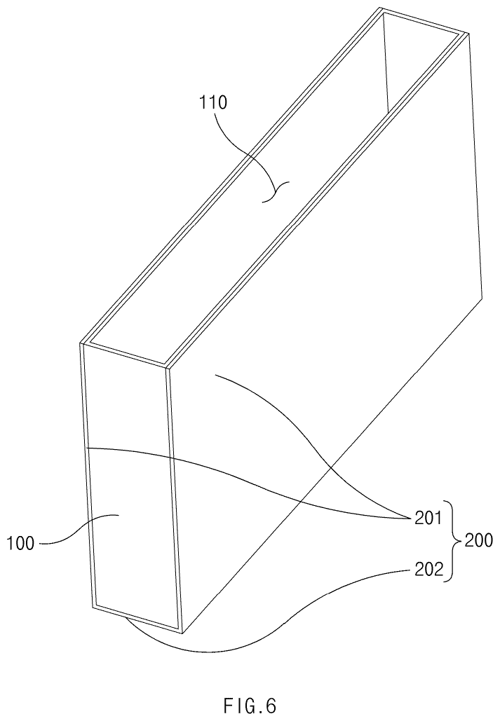

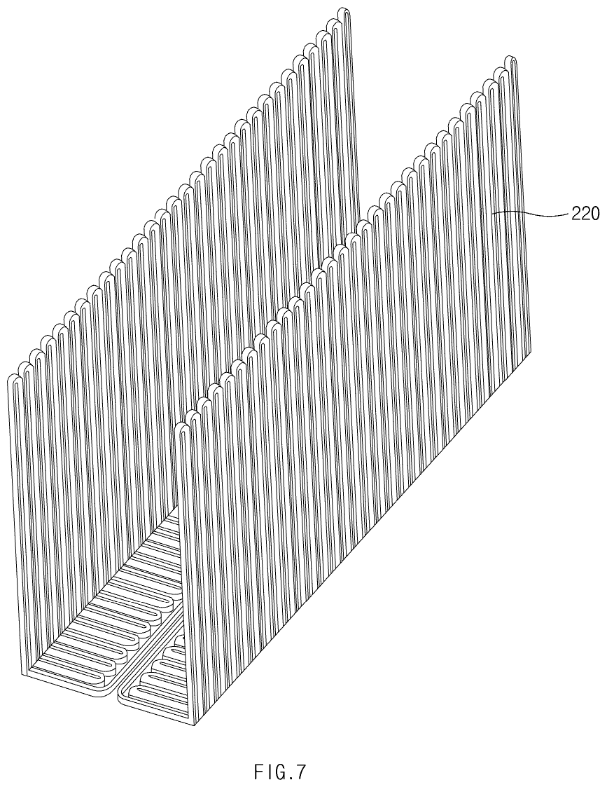

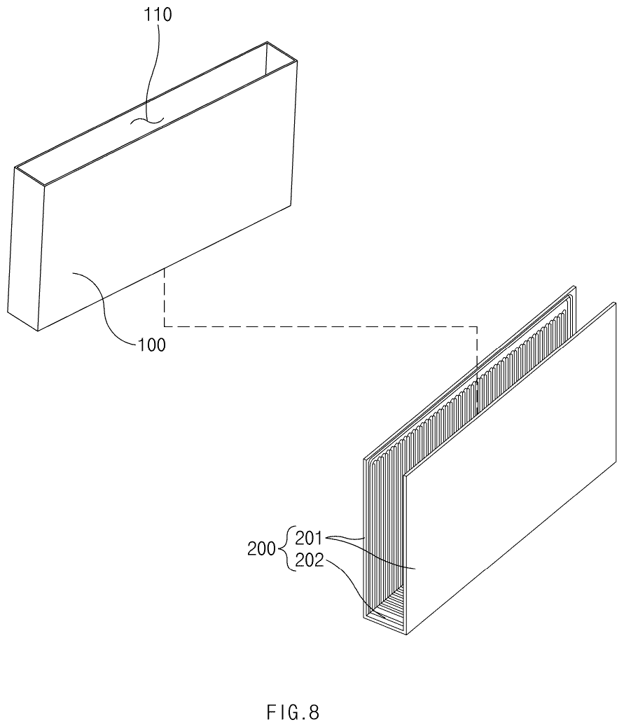

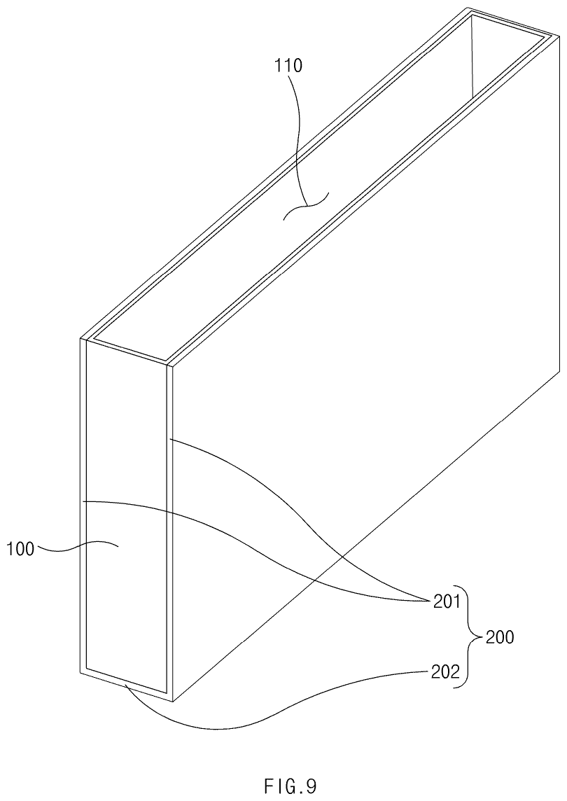

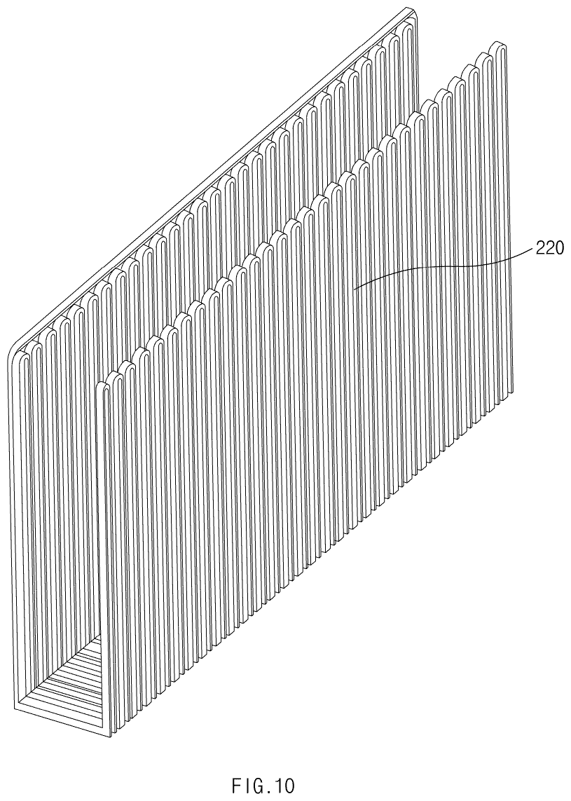

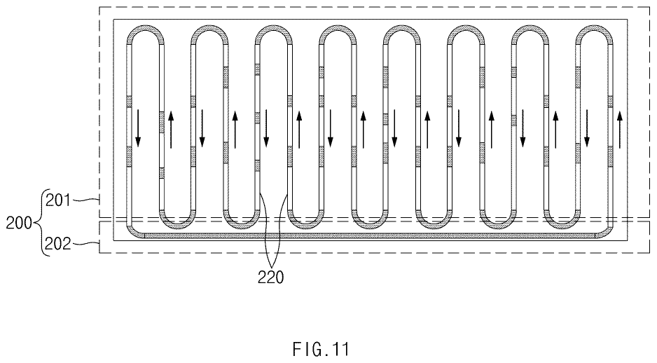

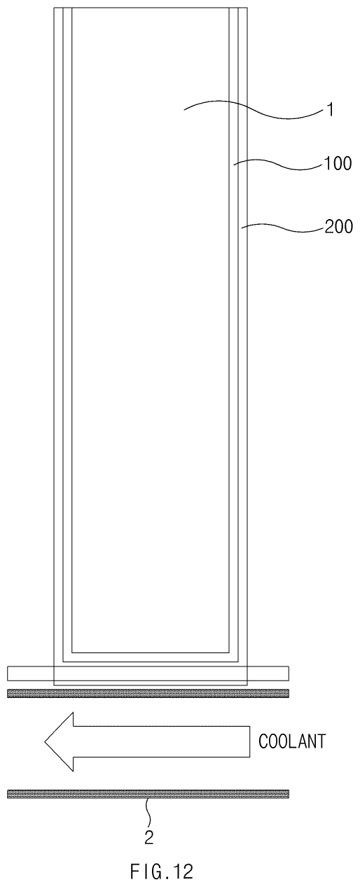

FIG. 1 is a perspective view exemplarily illustrating a structure in which a front stack of a battery according to an exemplary embodiment of the present disclosure is separated, FIG. 2 is an exploded perspective view exemplarily illustrating that a battery according to various exemplary embodiments of the present disclosure is disassembled, FIG. 3 is a perspective view exemplarily illustrating a structure in which the battery according to the various exemplary embodiments of the present disclosure is assembled, FIG. 4 is a perspective view exemplarily illustrating a structure of a flow path formed in the battery according to the various exemplary embodiments of the present disclosure, FIG. 5 is an exploded perspective view exemplarily illustrating that a battery according to various exemplary embodiments of the present disclosure is disassembled, FIG. 6 is a perspective view exemplarily illustrating a structure in which the battery according to the various exemplary embodiments of the present disclosure is assembled, FIG. 7 is a perspective view exemplarily illustrating a structure of a flow path formed in the battery according to the various exemplary embodiments of the present disclosure, FIG. 8 is an exploded perspective view exemplarily illustrating that a battery according to various exemplary embodiments of the present disclosure is disassembled, FIG. 9 is a perspective view exemplarily illustrating a structure in which the battery according to the various exemplary embodiments of the present disclosure is assembled, FIG. 10 is a perspective view exemplarily illustrating a structure of a flow path formed in the battery according to the various exemplary embodiments of the present disclosure, FIG. 11 is a top plan view exemplarily illustrating a structure of a flow path formed in a refrigerant portion of the battery according to an exemplary embodiment of the present disclosure, and FIG. 12 is a top plan view exemplarily illustrating a structure in which the battery according to an exemplary embodiment of the present disclosure is provided at one side of a coolant channel 2.

As illustrated in these drawings, a battery according to an exemplary embodiment of the present disclosure includes a battery accommodation portion 100 accommodating an electrode stack 1 including electrodes and separators, and a cooling portion 200 including recessed grooves 210 formed in a plate surface, the cooling portion 200 being disposed to be tightly attached to an external surface of the battery accommodation portion 100 and configured to define flow paths 220 in a space between the recessed grooves 210 and the external surface of the battery accommodation portion 100 so that a refrigerant flows along the flow paths 220.

As illustrated in FIG. 1, the electrode stack 1 may be configured as a jelly-roll-type cell assembly including a structure in which a separator is located between positive and negative electrodes of long sheet shapes, and then the separator and the positive and negative electrodes are wound, a stack-type cell assembly including unit cells each including a structure in which rectangular positive and negative electrodes are stacked with separators interposed therebetween, a stack-folding-type cell assembly in which unit cells are wound by a long separation film, or a lamination-stack-type cell assembly in which unit cells are stacked with separators interposed therebetween, and the unit cells are attached to each other.

The electrode stack 1 is embedded in a casing. The casing typically includes a laminated sheet structure of an internal layer, a metal layer, and an external layer.

Because the internal layer is in direct contact with a cell assembly, the internal layer requires insulation, electrolyte resistance, and sealability. The internal layer may be made of a material selected from polyolefin-based resins, such as polypropylene, polyethylene, polyethylene acrylic, polybutylene, polyurethane resin, and polyimide resin.

Furthermore, the metal layer, which adjoins the internal layer, is a barrier layer configured to prevent moisture or various types of gases from penetrating into the inside of the battery from the outside thereof. As a preferable material of the metal layer, an aluminum film, which is light in weight and has excellent formability, may be used.

Furthermore, the external layer may be provided on the other side surface of the metal layer. The external layer may be made of a heat resistance polymer, e.g., nylon or polyethylene terephthalate with s excellent tensile strength, moisture penetration prevention, and anti-air permeability to protect the electrode assembly and ensure heat resistance and chemical resistance. However, the present disclosure is not limited thereto.

The battery accommodation portion 100 is a member formed in a rectangular shape and includes a predetermined internal space 110 configured for accommodating the electrode stack 1. An upper side of the battery accommodation portion 100 may include an opening to accommodate the electrode stack 1 therethrough.

Such battery accommodation portion 100 may be effective to be made of a metallic material, such as aluminum, having high thermal conductivity to rapidly conduct heat generated when the electrode stack 1 is charged or discharged by use.

Furthermore, the cooling portion 200 to be described below may be disposed to be tightly attached to the external surface of the battery accommodation portion 100 so that the interiors of the flow paths 220 are smoothly formed when the flow paths 220 are formed. Therefore, the external surface of the cooling portion 200 may be smoothly formed to minimize resistance when the refrigerant accommodated in the flow paths 220 flow.

Furthermore, it is effective that the external surface of the cooling portion 200 is formed to be flat, and the cooling portion 200 is disposed to be tightly attached to the battery accommodation portion 100 to define the flow paths 220 so that the flow paths 220 may be formed in a flat surface to minimize resistance of the refrigerant when the refrigerant flows.

Furthermore, the battery accommodation portion 100 is formed in an angular shape and accommodates the electrode stack 1 therein so that an angular cell unit may be formed.

### First Exemplary Embodiments

As illustrated in FIG. 2, FIG. 3 and FIG. 4, the cooling portion 200 of the battery according to the various exemplary embodiments of the present disclosure includes the recessed grooves 210 formed in the plate surface, and the cooling portion 200 is disposed to be tightly attached to the external surface of the battery accommodation portion 100 so that the flow paths 220, along which the refrigerant flows, may be formed in the space between the recessed grooves 210 and the external surface of the battery accommodation portion 100.

That is, the cooling portion 200 may be tightly attached to and formed integrally with the battery accommodation portion 100 formed as the angular cell unit.

In general, to eliminate heat generated from the electrode stack 1, the cooling portion defines a sealed structure shieled from the outside thereof, and one side surface of the cooling portion is in contact with the casing, in which the electrode stack is accommodated, to cool the casing in a state in which the refrigerant flows into the cooling portion.

In contrast, in the cooling portion 200 of the battery according to an exemplary embodiment of the present disclosure, the battery accommodation portion 100, in which the electrode stack 1 is accommodated, and a cooling plate, which forms the cooling portion 200, are joined and integrated so that the flow paths 220 along which the refrigerant flows may be formed in the cooling portion 200 to cool the battery accommodation portion 100.

The cooling plate, which forms the cooling portion 200, and the battery accommodation portion 100 may be joined in various ways. However, it is effective that the cooling portion 200 of the battery according to an exemplary embodiment of the present disclosure may be joined to the battery accommodation portion 100 by brazing and integrated with the battery accommodation portion 100.

The recessed grooves 210 may be formed to be debossed in the plate surface of the cooling portion 200 so that the flow paths 220 may be formed between the external surface of the battery accommodation portion 100 and the cooling portion 200. The recessed grooves 210 may be formed to linearly fluidically communicate with one another so that the flow paths 220 defined by the recessed grooves 210 may be formed to linearly fluidically communicate with one another over the entire plate surface of the cooling portion 200.

Furthermore, it is effective that regions of the flow paths 220, which are disposed at end portions of the plate surface of the cooling portion 200, are repeatedly bent so that the flow paths 220 are continuously formed in a direction of the plate surface of the cooling portion 200. Furthermore, it is effective that two opposite end portions of the flow path 220 may fluidically communicate with each other to define a closed loop.

Furthermore, the refrigerant is filled in the flow paths 220, and the refrigerant circulates along the flow paths 220, which define the closed loops, while repeatedly condensing and vaporizing so that the refrigerant may eliminate heat generated from the electrode stack 1.

With reference to FIG. 11 and FIG. 12, a process in which the refrigerant accommodated in the flow paths 220 repeatedly condenses and vaporizes will be described. When the heat generated from the electrode stack 1 is transferred to the battery accommodation portion 100 and the heat transferred to the battery accommodation portion 100 is transferred to the cooling portion 200, a liquid refrigerant located in a vaporization portion 201 vaporizes while absorbing the heat, and the vaporized refrigerant is pushed toward a condensation portion 202 due to volume expansion thereof.

Furthermore, the gaseous refrigerant, which is pushed toward the condensation portion 202, dissipates the absorbed heat to an external coolant side and then is liquefied. The gaseous refrigerant, which is continuously pushed toward the condensation portion 202, moves the liquid refrigerant back to the vaporization portion 201 so that the condensation and the vaporization are repeated.

The cooling portion 200 may include the vaporization portion 201 disposed to be tightly attached to one side surface of the battery accommodation portion 100 and configured to allow the refrigerant to vaporize in the flow path 220, and the condensation portion 202 disposed to be tightly attached to a lower surface of the battery accommodation portion 100 and configured to pass the external coolant the condensation portion 202 to allow the refrigerant to condense in the flow path 220.

In the instant case, it is effective that the vaporization portion 201 is disposed to be tightly attached to the side surface of the battery accommodation portion 100 including a relatively large area, maximizing an area in which heat-exchange is performed so that the heat generated from the electrode stack 1 may be rapidly dissipated.

Processes of manufacturing the cooling portion 200 may be broadly classified into two processes. In a first process, one side of a single cooling plate including a plate shape is bent so that one portion of the single cooling plate defines the vaporization portion 201 tightly attached to one side surface of the battery accommodation portion 100, and the other portion of the single cooling plate defines the condensation portion 202 so that the cooling portion including a longitudinal section including a ‘L’ shape as a whole may be manufactured.

In a second process, a plurality of cooling plates each including a plate shape are joined to one another by brazing so that some of the plurality of cooling plates define the vaporization portion 201 tightly attached to one side surface of the battery accommodation portion 100, and some of the remaining plurality of cooling plates define the condensation portion 202 so that the cooling portion including a longitudinal section including a ‘L’ shape as a whole may be manufactured.

However, in case that the plurality of cooling plates are joined to one another by brazing to define the vaporization portion 201 and the condensation portion 202, it is necessary to perform a process of precisely aligning a boundary region between the vaporization portion 201 and the condensation portion 202 so that the recessed grooves 210, which form the flow paths 220, are continuously formed in the boundary region.

### Second Exemplary Embodiments

As illustrated in FIG. 5, FIG. 6 and FIG. 7, the cooling portion 200 of the battery according to the various exemplary embodiments of the present disclosure includes the recessed grooves 210 formed in the plate surface, and the cooling portion 200 is disposed to be tightly attached to the external surface of the battery accommodation portion 100 so that the flow paths 220, along which the refrigerant flows, may be formed in the space between the recessed grooves 210 and the external surface of the battery accommodation portion 100.

That is, the cooling portion 200 may be tightly attached to and formed integrally with the battery accommodation portion 100 formed as the angular cell unit.

The recessed grooves 210 may be formed to be debossed in the plate surface of the cooling portion 200 so that the flow paths 220 may be formed between the external surface of the battery accommodation portion 100 and the cooling portion 200. The recessed grooves 210 may be formed to linearly fluidically communicate with one another so that the flow paths 220 defined by the recessed grooves 210 may be formed to linearly fluidically communicate with one another over the entire plate surface of the cooling portion 200.

Furthermore, it is effective that the regions of the flow paths 220, which are disposed at the end portions of the plate surface of the cooling portion 200, are repeatedly bent so that the flow paths 220 are continuously formed in the direction of the plate surface of the cooling portion 200. Furthermore, it is effective that the two opposite end portions of the flow path 220 may fluidically communicate with each other to define the closed loop.

Furthermore, the refrigerant is accommodated in the flow paths 220, and the refrigerant circulates along the flow paths 220, which define the closed loops, while repeatedly condensing and vaporizing so that the refrigerant may eliminate heat generated from the electrode stack 1.

With reference to FIG. 11 and FIG. 12, the process in which the refrigerant accommodated in the flow paths 220 repeatedly condenses and vaporizes will be described. When the heat generated from the electrode stack 1 is transferred to the battery accommodation portion 100 and the heat transferred to the battery accommodation portion 100 is transferred to the cooling portion 200, the liquid refrigerant positioned in the vaporization portion 201 vaporizes while absorbing the heat, and the vaporized refrigerant is pushed toward the condensation portion 202 due to volume expansion.

Furthermore, the gaseous refrigerant, which is pushed toward the condensation portion 202, dissipates the absorbed heat to the external coolant and then is liquefied. The gaseous refrigerant, which is continuously pushed toward the condensation portion 202, moves the liquid refrigerant back to the vaporization portion 201 so that the condensation and the vaporization are repeated.

The cooling portions 200 are provided as two cooling portions 200 disposed to be symmetric with respect to the battery accommodation portion 100 so that the vaporization portions 201 may be respectively tightly attached to two opposite surfaces of the battery accommodation portion 100, and the condensation portions 202 may be tightly attached to a lower surface of the battery accommodation portion 100.

In the instant case, it is effective that the vaporization portion 201 is disposed to be tightly attached to the side surface of the battery accommodation portion 100 including a relatively large area, maximizing an area in which heat-exchange is performed so that the heat generated from the electrode stack 1 may be rapidly dissipated.

### Third Exemplary Embodiments

As illustrated in FIG. 8, FIG. 9 and FIG. 10, the cooling portion 200 of the battery according to the various exemplary embodiments of the present disclosure includes the recessed grooves 210 formed in the plate surface, and the cooling portion 200 is disposed to be tightly attached to the external surface of the battery accommodation portion 100 so that the flow paths 220, along which the refrigerant flows, may be formed in the space between the recessed grooves 210 and the external surface of the battery accommodation portion 100.

That is, the cooling portion 200 may be tightly attached to and formed integrally with the battery accommodation portion 100 formed as the angular cell unit.

The recessed grooves 210 may be formed to be debossed in the plate surface of the cooling portion 200 so that the flow paths 220 may be formed between the external surface of the battery accommodation portion 100 and the cooling portion 200. The recessed grooves 210 may be formed to linearly fluidically communicate with one another so that the flow paths 220 defined by the recessed grooves 210 may be formed to linearly fluidically communicate with one another over the entire plate surface of the cooling portion 200.

Furthermore, it is effective that the regions of the flow paths 220, which are disposed at the end portions of the plate surface of the cooling portion 200, are repeatedly bent so that the flow paths 220 are continuously formed in the direction of the plate surface of the cooling portion 200. Furthermore, it is effective that the two opposite end portions of the flow path 220 may fluidically communicate with each other to define the closed loop.

Furthermore, the refrigerant is accommodated in the flow paths 220, and the refrigerant circulates along the flow paths 220, which define the closed loops, while repeatedly condensing and vaporizing so that the refrigerant may eliminate heat generated from the electrode stack 1.

With reference to FIG. 11 and FIG. 12, the process in which the refrigerant accommodated in the flow paths 220 repeatedly condenses and vaporizes will be described. When the heat generated from the electrode stack 1 is transferred to the battery accommodation portion 100 and the heat transferred to the battery accommodation portion 100 is transferred to the cooling portion 200, the liquid refrigerant positioned in the vaporization portion 201 vaporizes while absorbing the heat, and the vaporized refrigerant is pushed toward the condensation portion 202 due to volume expansion.

Furthermore, the gaseous refrigerant, which is pushed toward the condensation portion 202, dissipates the absorbed heat to the external coolant and then is liquefied. The gaseous refrigerant, which is continuously pushed toward the condensation portion 202, moves the liquid refrigerant back to the vaporization portion 201 so that the condensation and the vaporization are repeated.

The cooling portions 200 are provided as two cooling portions 200 disposed to be symmetric with respect to the battery accommodation portion 100 so that the vaporization portions 201 may be respectively tightly attached to two opposite surfaces of the battery accommodation portion 100, and the condensation portions 202 may be tightly attached to a lower surface of the battery accommodation portion 100.

In the instant case, it is effective that the vaporization portion 201 is disposed to be tightly attached to the side surface of the battery accommodation portion 100 including a relatively large area, maximizing an area in which heat-exchange is performed so that the heat generated from the electrode stack 1 may be rapidly dissipated.

Processes of manufacturing the cooling portion 200 may be broadly classified into two processes. In a first process, a plurality of portions of a single cooling plate including a plate shape are bent so that some of the plurality of portions define the vaporization portions 201 tightly attached to the two opposite surfaces of the battery accommodation portion 100, and some of the remaining plurality of portions define the condensation portion 202 tightly attached to the lower surface of the battery accommodation portion 100 so that the cooling portion may be manufactured.

In a second process, three cooling plates each including a plate shape are joined to one another by brazing to be perpendicular to one another so that some of the three cooling plates define the vaporization portions 201 tightly attached to the two opposite surfaces of the battery accommodation portion 100, and the other cooling plate defines the condensation portion 202 tightly attached to the lower surface of the battery accommodation portion 100 so that the cooling portion may be manufactured.

However, as in the various exemplary embodiments of the present disclosure, in case that the three cooling plates are joined to one another by mutually brazing to be perpendicular to one another to define the vaporization portions 201 and the condensation portion 202, it is necessary to perform a process of precisely aligning boundary regions between the vaporization portions 201 and the condensation portion 202 so that the recessed grooves 210, which form the flow paths 220, are continuously formed in the boundary regions.

According to the battery according to an exemplary embodiment of the present disclosure configured as described above, the performance in dissipating heat from the battery cell may be improved, shortening the fast-charging time, ensuring the high output of the battery cell, and reducing the costs and weight.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a predetermined condition is satisfied, to perform the related operation or interpret the related definition according to the predetermined condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery comprising:
a battery accommodation portion accommodating an electrode stack including an electrode and a separator; and
a cooling portion including recessed grooves formed in a plate surface of the cooling portion, the cooling portion attached to an external surface of the battery accommodation portion and defining flow paths in a space between the recessed grooves and the external surface of the battery accommodation portion so that a refrigerant flows along the flow paths.

2. The battery of claim 1, wherein regions of the flow paths, which are disposed at end portions of the plate surface of the cooling portion, are repeatedly bent so that the flow paths are continuously formed in a direction of the plate surface of the cooling portion, and first and second opposite end portions of the flow paths fluidically communicate with each other to define a closed loop.

3. The battery of claim 2, wherein the cooling portion includes:
a vaporization portion attached to at least one side surface of the battery accommodation portion so that the refrigerant vaporizes in the flow paths; and
a condensation portion attached to a lower surface of the battery accommodation portion to condense the refrigerant in the condensation portion.

4. The battery of claim 3, wherein a coolant flows passes on the condensation portion so that the refrigerant condenses in the flow paths.

5. The battery of claim 3, wherein the cooling portion is configured by a single cooling plate including a plate shape, and the cooling plate is bent so that a first portion of the cooling plate defines the vaporization portion attached to one side surface of the battery accommodation portion, and a second portion of the cooling plate defines the condensation portion attached to the lower surface of the battery accommodation portion so that a longitudinal section including a ‘L’ shape as a whole of the cooling portion is formed.

6. The battery of claim 3, wherein the cooling portion is configured by a plurality of cooling plates each including a plate shape, and the cooling plates are joined to one another by brazing so that some of the cooling plates define the vaporization portion attached to one side surface of the battery accommodation portion, and some of the remaining cooling plates define the condensation portion so that a longitudinal section including a ‘L’ shape as a whole of the cooling portion is formed.

7. The battery of claim 6, wherein the cooling portion is provided as two cooling portions disposed to be symmetric with respect to the battery accommodation portion so that the vaporization portions of the two cooling portions are respectively attached to two opposite surfaces of the battery accommodation portion, and the condensation portions of the two cooling portions are attached to the lower surface of the battery accommodation portion.

8. The battery of claim 4, wherein the cooling portion is configured by a single cooling plate including a plate shape, and a plurality of portions of the cooling plate are bent so that some of the plurality of portions define the vaporization portions attached to two opposite surfaces of the battery accommodation portion, and some of the remaining plurality of portions define the condensation portion attached to the lower surface of the battery accommodation portion.

9. The battery of claim 8, wherein the vaporization portions are formed at two opposite sides based on a bent region of the cooling plate, and the condensation portion, which is in thermal contact with the coolant, is formed between the vaporization portions.

10. The battery of claim 3, wherein the vaporization portion is disposed on a side surface of the battery accommodation portion including a relatively larger area than an area of the condensation portion.

11. The battery of claim 1, wherein the cooling portion is joined to the battery accommodation portion by brazing.

12. The battery of claim 11, wherein the cooling portion is formed integrally with the battery accommodation portion.

13. The battery of claim 11, wherein the battery accommodation portion is configured as an angular cell.

14. The battery of claim 1, further including a coolant channel disclosed on the cooling portion.

15. The battery of claim 1, wherein the recessed grooves is formed to be debossed in the plate surface of the cooling portion so that the flow paths are formed between the external surface of the battery accommodation portion and the cooling portion.
